(19) United States
(12) Patent Application Publication
(10) Pub. No.: US 2026/0218427 A1
(43) Pub. Date: Jul. 30, 2026

(54) STITCHBONDED AND GATHERED LYOCELL FABRIC UNIT

(71) Applicant: AMTEX INNOVATIONS LLC, West Chester, OH (US)

(72) Inventors: Geoffrey William COLLINS, Mason, OH (US); Maxwell James LEE, Maineville, OH (US)

(21) Appl. No.: 19/571,988

(22) Filed: Mar. 19, 2026

Related U.S. Application Data
(63) Continuation-in-part of application No. PCT/US2025/039245, filed on Jul. 25, 2025.
(60) Provisional application No. 63/675,395, filed on Jul. 25, 2024.

(51) Int. Cl. D04H 1/52; D04H 1/4258

(52) U.S. Cl. CPC D04H 1/52; D04H 1/4258; D10B 2201/01; D10B 2401/06

(57) ABSTRACT

A stitchbonded fabric having one or more nonwoven sheet consisting of cellulosic, preferably lyocell, fibers oriented multidirectionally within the sheet, and a pattern of stitches of shrinkable yarns that, after shrink-activating, gathers the fabric into a gathered stitchbonded fabric. The stitching has yarn overlaps over a technical front surface and yarn underlaps over a technical back surface of the nonwoven sheet. The cellulosic fibers provide a ratio of tensile strength in the machine:cross directions of the nonwoven sheet of 3:1 or less. The stitchbonded fabric unit contains 40% to 80% by weight cellulosic fibers, and 20% to 60% by weight shrinkable yarns, and has an MD:CD tensile strength ratio of 6:1 or less. The nonwoven cellulosic sheet and the gathered stitchbonded fabric therefrom contain a de minimis or no amount of binding fibers or adhesive material, to avoid interfering with the needles of the yarn stitching of the fabric unit.

### CROSS-REFERENCE TO RELATED APPLICATIONS

This application is a continuation-in-part of International Application No. PCT/US2025/039245 filed Jul. 25, 2025, which claims the benefit of U.S. Provisional Application No. 63/675,395 filed Jul. 25, 2024, the disclosures of which are hereby incorporated by reference in their entireties.

### FIELD OF THE INVENTION

This invention is related to the field of stitchbonded fabrics.

### BACKGROUND OF THE INVENTION

U.S. Pat. No. 11,220,086, the disclosure of which is incorporated by reference in its entirety, discloses a fabric and gathered towel with a first cellulosic nonwoven sheet and a second integrated nonwoven layer that are stitchbond-laminated and gathered using yarns that deployed under tension and relax in situ within the stitchbonded fabric. The first cellulosic nonwoven can be 100% lyocell. The second integrated nonwoven layer has a polyester layer on an inner face and a layer of wood pulp fiber on an outer face, with the two layers hydroentangled to form the integrated nonwoven that does not shrink or swell significantly. For example, a Sontara 8801 integrated fabric (68 grams per square meter, gsm), 55% wood pulp/45% polyester) has a thickness of 0.25-0.27 mm, a thickness after-tensionless wet processing of 0.45-0.48 mm, with a shrinkage of 2% in the MD, 1% in the CD, and a density of more than 0.15 g/cm³; a Sontara 8890 integrated fabric (90 gsm, 45% wood pulp/55% polyester) has a thickness of 0.37-0.39 mm, and a thickness after tensionless wet processing of 0.5-0.54 mm, with a shrinkage of 1% in the MD, 0% shrinkage in the CD, and a density of more than 0.15 g/cm³. The yarns include a zigzag pattern of stitching across the outer face of the wood pulp fibers layer that partially cover and protect the exposed wood pulp sublayer of the integrated nonwoven sheet on the technical back surface of the composite nonwoven fabric.

### SUMMARY OF THE INVENTION

The present invention provides a stitchbonded fabric unit comprising, consisting essentially of, or consisting of: (i) one or more nonwoven sheet comprising, consisting essentially of, or consisting of, cellulosic fibers, the cellulosic fibers oriented multidirectionally within the one or more nonwoven sheet; and (ii) a pattern of stitches of a shrinkable yarn that form a plurality of yarn overlaps over a technical front surface of the one or more nonwoven sheet and a plurality of yarn underlaps over a technical back surface of the one or more nonwoven sheet. The un-stitched one or more nonwoven sheet has a ratio of a tensile strength in a machine-direction (MD) to a tensile strength in a cross-direction (CD) of about 5:1 or less, including about 4:1 or less, and preferably a tensile strength ratio of about 3.0:1 or less, more preferably about 2.0:1 or less, and even more preferably about 1.5:1 or less.

Upon cutting and removing the pattern of stitches of the shrinkable yarn from the stitchbonded fabric unit, the de-stitched non-woven sheet has a ratio of a tensile strength in a machine-direction (MD) to a tensile strength in a cross-direction (CD) of about 5:1 or less, including about 4:1 or less, and preferably a tensile strength ratio of about 3.0:1 or less, more preferably about 2.0:1 or less, and even more preferably about 1.5:1 or less, and is similar or substantially unchanged compared to the MD:CD ratio of the un-stitched nonwoven sheet.

In various embodiments, the resulting stitchbonded fabric unit has a ratio of a tensile strength in a machine-direction (MD) to a tensile strength in a cross-direction (CD) of about 8.0:1 or less, including about 6.0:1 or less, preferably about 4.0:1 or less, more preferably about 3.0:1 or less, and even more preferably about 2.0:1 or less.

The present invention also provides a stitchbonded fabric unit comprising, consisting essentially of, or consisting of: (i) one or more nonwoven sheet comprising, consisting essentially of, or consisting of, cellulosic fibers, the cellulosic fibers oriented multidirectionally within the one or more nonwoven sheet to provide the one or more nonwoven sheet with a ratio of a tensile strength in a machine-direction (MD) to a tensile strength in a cross-direction (CD) of about 5:1 or less, including about 4:1 or less, and preferably a tensile strength ratio of about 3.0:1 or less, more preferably about 2.0:1 or less, and even more preferably about 1.5:1 or less; and (ii) a pattern of stitches of a shrinkable yarn that form a plurality of yarn overlaps over a technical front surface of the one or more nonwoven sheet and a plurality of yarn underlaps over a technical back surface of the one or more nonwoven sheet; wherein the resulting stitchbonded fabric unit has a ratio of a tensile strength in a machine-direction (MD) to a tensile strength in a cross-direction (CD) of about 8.0:1 or less, including about 6.0:1 or less, preferably about 4.0:1 or less, more preferably about 3.0:1 or less, and even more preferably about 2.0:1 or less.

When the stitches of the shrinkable yarn and the one or more nonwoven sheet of the stitchbonded fabric unit are shrink-activated in a post-treatment shrinking process, the stitchbonded fabric unit is gathered to form a gathered stitchbonded fabric unit having a ratio of a tensile strength in a machine-direction (MD) to a tensile strength in a cross-direction (CD) of about 6.0:1 or less, more typically about 5.0:1 or less, preferably about 4.0:1 or less, more preferably about 3.0:1 or less, and even more preferably about 2.0:1 or less.

In various embodiments, the plurality of yarn underlaps comprise stitches formed in a zig-zag stitch pattern, angled in the cross direction (CD), that extend the advancing shrinkable yarn diagonally from a starting row to an adjacent row, or across the first adjacent row to a next second row, and then diagonally back to the starting row. When activated, the shrinking of the diagonal stitches can increase the tensile strength of the gathered stitchbonded fabric unit in the CD direction.

In various embodiments, a nonwoven sheet can comprise, consist essentially of, or consist of, a multistrata nonwoven sheet comprising two or more strata of cellulosic fibers. As used herein, the term “strata” and “stratum” refer to a layered region or regions of cellulosic fibers that form a unitary structure comprising the nonwoven sheet. The combination of two or more strata of the nonwoven sheet is not an assembly or laminate of preformed layers forming a multi-layered structure. Rather the multistrata nonwoven sheet is constructed by forming and assembling the two or more strata in an integral manner to form a nonwoven sheet. In some forms, where adjacent (overlapping or laminated) strata are indistinguishable, the adjacent strata may be a single stratum.

In various embodiments, the stitchbonded fabric unit comprises, by weight, at least about 30%, which can include at least about 40%, at least about 50%, at least about 60%, and at least about 70%, of the cellulosic fibers. In some embodiments, stitchbonded fabric unit comprises, by weight, up to about 90%, which can include up to about 80%, up to about 70%, up to about 60%, and up to about 50%, of the cellulosic fibers.

In various embodiments, stitchbonded fabric unit comprises, by weight, at least about 10%, which can include at least about 20%, of the shrinkable yarn. In some embodiments, the shrinkable yarn comprises, by weight, up to about 70%, which can include up to about 60%, of the shrinkable yarn.

In some embodiments, the stitchbonded fabric unit comprises, by weight, about 30% to about 90% of the cellulosic fibers, and about 10% to about 70% of the shrinkable yarn.

In some embodiments, the stitchbonded fabric unit comprises about 60% to about 90% by weight of the one or more nonwoven sheet, and about 10% to about 40%, by weight of the shrinkable yarn.

In some embodiments, the stitchbonded fabric unit comprises, by weight, about 30% to about 60% of the cellulosic fibers of the one or more nonwoven sheet, and about 40% to about 70% of the shrinkable yarn.

In some embodiments, the one or more nonwoven sheet comprises a multistrata nonwoven sheet comprising, consisting essentially of, or consisting of, two or more strata, wherein the plurality of cellulosic fibers, and preferably most or substantially all the plurality of cellulosic fibers, of each stratum are oriented non-axially to a main direction of the one or more nonwoven sheet.

In some embodiments, the plurality of cellulosic fibers comprise, consist essentially of, or consists of, a plurality of lyocell fibers.

In some embodiments, the one or more nonwoven sheet contains essentially no binding fibers or adhesive material.

The present invention further provides a stitchbonded fabric unit, comprising, consisting essentially, or consisting of, (i) one or more nonwoven sheet, preferably one or more multistrata nonwoven sheet, wherein the one or more multistrata nonwoven sheet comprises, consists essentially of, or consists of, two or more strata, each stratum comprising, consisting essentially of, or consisting of, a plurality of cellulosic fibers, and (ii) a pattern of stitches of a shrinkable yarn. The plurality of cellulosic fibers of the one or more nonwoven sheet comprise about 30% to about 90% by weight of the stitchbonded fabric unit. The shrinkable yarn comprises about 10% to about 70% by weight of the stitchbonded fabric unit. The pattern of stitches form a plurality of yarn overlaps over a technical front surface and yarn underlaps over a technical back surface of the one or more nonwoven sheet.

In various embodiments, the multistrata nonwoven sheet has a ratio of a tensile strength in a machine-direction (MD) to a tensile strength in a cross-direction (CD) of 5:1 or less, or typically 4:1 or less, and preferably 3.0:1 or less, and more preferably 2.0:1 or less.

In various embodiments, the stitchbonded fabric unit has a ratio of a tensile strength in a machine-direction (MD) to a tensile strength in a cross-direction (CD) of about 8.0:1 or less, typically 6.0:1 or less, preferably about 4.0:1 or less, more preferably about 3.0:1 or less, and even more preferably about 2.0:1 or less.

The stitchbonded fabric unit can be shrink-activated in a post-treatment shrinking process to gather the one or more nonwoven sheet and the pattern of the stitches of the shrinkable yarn, forming a gathered stitchbonded fabric unit.

In various embodiments, most or substantially all the plurality of cellulosic fibers of each stratum of a multistrata nonwoven sheet are oriented non-axially to a main sheet direction of the multistrata nonwoven sheet, to provide the multistrata nonwoven sheet with a ratio of a tensile strength in a machine-direction (MD) to a tensile strength in a cross-direction (CD) of 5.0:1 or less, or typically 4:1 or less, and preferably 3.0:1 or less, and more preferably 2.0:1 or less.

In various embodiments, the plurality of cellulosic fibers of each stratum are principally oriented multidirectionally, and at angles up to 90 degrees from a main sheet direction of the nonwoven sheet.

In various embodiments, the plurality of cellulosic fibers of each stratum are principally oriented in the main stratum direction non-axially to a main direction of the one or more nonwoven sheets, and typically individually at an angle or angles up to 90 degrees from a main direction of the nonwoven sheet.

In various embodiments the plurality of cellulosic fibers of each stratum are oriented non-axially to the main direction of the nonwoven sheet. As is understood by one of ordinary skill in the art, in general, the greater the multidirectionality of the cellulosic fibers of a stratum from the main direction of the nonwoven sheet, the lower the MD:CD ratio of the nonwoven sheet.

A tensile strength of a nonwoven sheet, a stitchbonded fabric unit, or a gathered stitchbonded fabric unit, is determined by ASTM D-5034, measuring the force in newtons (N) per centimeter width of the sample of the sheet or fabric unit.

In various embodiments, the multistrata nonwoven sheet contains essentially no binding fibers or adhesive material. As used here, a nonwoven sheet, including a multistrata nonwoven sheet, that contains essentially no binding fibers or adhesive material, also referred to as a de minimus amount of binder fibers or adhesive material, is a presence of binder fibers and adhesive material having a size or dimension, and a quantity thereof, that does not inhibit, interfere with, or otherwise impact the penetration of stitching needles in a yarn stitching process, nor affects in an significant way the gathering, absorbency or an increase in thickness of the nonwoven sheet. Essentially no binding fibers or adhesive material can include about 5% or less, about 2% or less, about 1% or less, about 0.5% or less, or about 0.1% or less, by weight, binding fibers or adhesive material, and can include no binding fibers or adhesive material.

The present invention also provides a stitchbonded fabric unit comprising, consisting essentially of, or consisting of: (i) one or more nonwoven sheet comprising, consisting essentially of, or consisting of, cellulosic fibers, the cellulosic fibers oriented multidirectionally within the one or more nonwoven sheet; and (ii) a pattern of stitches of a shrinkable yarn that form a plurality of yarn overlaps over a technical front surface of the one or more nonwoven sheet and a plurality of yarn underlaps over a technical back surface of the one or more nonwoven sheet; wherein the stitchbonded fabric unit has a ratio of a tensile strength in a machine-direction (MD) to a tensile strength in a cross-direction (CD) of about 8.0:1 or less, typically 6.0:1 or less, preferably about 4.0:1 or less, more preferably about 3.0:1 or less, and even more preferably about 2.0:1 or less.

The present invention further provides a gathered stitchbonded fabric unit, comprising, consisting essentially of, or consisting of, (i) one or more nonwoven sheet, comprising, consisting essentially of, or consisting of, a plurality of cellulosic fibers, the plurality of cellulosic fibers comprising about 40% to about 80% by weight of the gathered stitchbonded fabric unit, wherein the plurality of cellulosic fibers are oriented multidirectionally within the one or more nonwoven sheet; and (ii) a pattern of stitches of a shrunken yarn that gather the one or more nonwoven sheet, forming a plurality of yarn overlaps over a technical front surface and a plurality of yarn underlaps over a technical back surface of the gathered one or more nonwoven sheet, the shrunken yarn comprising about 20% to about 60% by weight of the gathered stitchbonded fabric unit, wherein the one or more un-stitched nonwoven sheet has a ratio of a tensile strength in a machine direction (MD) to a tensile strength in a cross direction (CD) of about 5:1 or less, including 4:1 or less, and preferably a tensile strength ratio of 3.0:1 or less, more preferably about 2.0:1 or less, and even more preferably 1.5:1 or less.

Upon cutting and removing the pattern of stitches of the gathered shrinkable yarn from the gathered stitchbonded fabric unit, the de-stitched non-woven sheet has a ratio of a tensile strength in a machine-direction (MD) to a tensile strength in a cross-direction (CD) of about 5:1 or less, including 4:1 or less, and preferably a tensile strength ratio of 3.0:1 or less, more preferably about 2.0:1 or less, and even more preferably about 1.5:1 or less, and is similar or substantially unchanged compared to the MD:CD ratio of the un-stitched nonwoven sheet.

In various embodiments, the one or more nonwoven sheet comprises or consists of one or more, and preferably two or more, multistrata nonwoven sheet.

In various embodiments, the one or more nonwoven sheet has a main sheet direction, designated as a machine direction (MD), and a cross direction (CD) transverse to the MD.

In various embodiments, the plurality of cellulosic fibers comprise, consist essentially of, or consists of, a plurality of lyocell fibers.

In some embodiments, the one or more nonwoven sheet contains essentially no binding fibers or adhesive material.

In various embodiments, the gathered stitchbonded fabric unit has a tensile strength ratio of MD:CD of about 6.0:1 or less, typically about 5.0:1 or less, and contains essentially no binding fibers or adhesive material. In some embodiments, the tensile strength ratio of MD:CD of about 4.0:1 or less, and preferably about 3.0:1 or less.

In various embodiments, the gathered stitchbonded fabric unit is a size-stable fabric unit that is durable to multiple cycles of commercial laundering and use, with a net area shrinkage of 20% or less, determined by method AATCC 61 through 5 cycles. In some embodiments, the net area shrinkage is typically 15% or less, more typically 10% or less.

In various embodiments, the plurality of yarn underlaps comprise stitches formed in a zig-zag stitch pattern, angled in the cross direction (CD), that extends the advancing shrinkable yarn diagonally from a starting row to an adjacent row, or across the first adjacent row to a next second row, and then diagonally back to the starting row. The shrunken diagonal stitches increase the tensile strength of the gathered stitchbonded fabric unit in the CD direction.

In embodiments having a multistrata nonwoven sheet, the cellulosic fibers are oriented primarily in a direction non-axial to the main sheet direction of the multistrata nonwoven sheet, to provide the multistrata nonwoven sheet with a ratio of a tensile strength in a machine-direction (MD) to a tensile strength in a cross-direction (CD) of about 3:1 or less.

The gathered stitchbonded fabric unit is typically formed by shrink-activating a stitchbonded fabric unit in a post-treatment shrinking process to gather the one or more nonwoven sheet and the pattern of the stitches of the shrinkable yarn.

U.S. Pat. No. 7,452,835, the disclosure of which is incorporated by references in its entirety, discloses that the orientation of fibers with respect to the machine direction and cross direction can have a significant impact upon the resultant properties and characteristics of the nonwoven sheet. As will be recognized by those familiar with the art, a nonwoven sheet may be formed by a 100% in-line card which refers to a staple fiber web formed entirely from carded fibers wherein most or substantially all the fibers are principally oriented in the machine direction of the web.

In contrast, in various embodiments a nonwoven sheet can be made by cross-lapping two or more strata that have been formed as in-line carded web strata. Most (greater than a majority) or substantially all (more than 80-90%) of the plurality of the cellulosic fibers of each stratum are oriented primarily in a main stratum direction, and a main stratum direction of a one stratum is oriented at an angle of up to 90 degrees from a main stratum direction of the next stratum, which results in the plurality of cellulosic fibers being oriented at an angle non-axially to the main direction of the nonwoven sheet. An example of equipment used to create multistrata crosslap carded webs is disclosed in U.S. Pat. No. 7,810,218, the disclosure of which is incorporated by reference in its entirety. U.S. Pat. No. 5,475,903, the disclosure of which is incorporated by reference in its entirety, illustrates a web drafting apparatus.

In various embodiments, the plurality of cellulosic fibers of each stratum are formed whereby the plurality of cellulosic fibers are oriented multidirectionally, and in some embodiments randomly, relative to the main stratum direction of the stratum. Such randomly-carded strata can be oriented with the main strata direction coaxial with the machine direction of the nonwoven sheet, or can be cross-lapped to orient the main strata direction non-axial and angled relative to the machine direction of the nonwoven sheet. Typically, a plurality of the cellulosic fibers in one or more stratum is oriented at an angle of up to 90 degrees from a plurality of the cellulosic fibers of the next stratum, to provide a cellulosic nonwoven sheet having two or more strata having fibers that are oriented multidirectionally and non-axially relative to the main sheet direction of the nonwoven sheet. Such multidirectional orientation of the fibers is sometimes termed “random carding” that uses a random carding system, such as one described in U.S. Pat. No. 11,987,916, the disclosure of which is incorporated by reference in its entirety.

Various embodiments of the present invention use a multistrata nonwoven cellulosic sheet that has a machine direction MD and a cross-direction CD comprising, consisting essentially of, or consisting of, a plurality of cellulosic fibers. In each stratum, most (greater than a majority), and typically substantially all (more than 90-95%) of the plurality of cellulosic fibers are oriented non-axially to, and at an angle relative to, a main sheet direction of the nonwoven sheet, to avoid having the plurality of cellulosic fibers principally oriented in the machine direction of the nonwoven sheet.

In various embodiments, the gathered stitchbonded fabric unit has a density of 0.20 g/cm³ or less. In some embodiments, the density can be 0.18 g/cm³ or less, or 0.15 g/cm³ or less.

In various embodiments, the gathered stitchbonded fabric unit has an absorbency of at least 3 times its own weight. In some embodiments, the absorbency can be at least 3.5, or at least 4.0 times their own weight.

In various embodiments, the gathered stitchbonded fabric unit has a thickness of 1.3 mm or more. In some embodiments, the thickness can be 1.5 mm or more, 1.7 mm or more, or 1.9 mm or more. In some embodiments, the thickness can be up to 2.5 mm, or up to 2.0 mm, or up to 1.8 mm.

In various embodiments, the thickness of the gathered stitchbonded fabric unit is 130% or more of the thickness of the ungathered stitchbonded fabric unit; that is, a thickness increase upon gathering is 30% or more, which can include an increase of 40% or more, 50% or more, 60% or more, or 70% or more.

In various embodiments, the gathered stitchbonded fabric unit a CLO of 0.25 or more.

In various embodiments, the gathered stitchbonded fabric unit a thermal effusivity of less than 100, or less than 95, or less than 80.

In various embodiments, the multistrata nonwoven sheet has an MD:CD ratio of 2:1 or less.

In various embodiments, the gathered stitchbonded fabric unit is a size-stable fabric unit that is durable to multiple cycles of commercial laundering and use, with a net area shrinkage of 20% or less, determined by method AATCC 61 through 5 cycles. In some embodiments, the net area shrinkage is typically 15% or less, more typically 10% or less.

In the embodiments described herein, the cellulosic fibers of a nonwoven sheet, of a stitchbonded fabric or fabric unit, and/or of a gathered stitchbonded fabric or fabric unit, can comprise, consist essentially of, or consist of, lyocell fibers, cotton fibers, viscose fibers, or a any mixture or combination thereof. In some preferred embodiments, the cellulosic fibers comprise, consist essentially of, or consist of, lyocell fibers. In some embodiments, the cellulosic fibers comprise, consist essentially of, or consist of cotton fibers. In some embodiments, the cellulosic fibers comprise, consist essentially of, or consist of viscose fibers.

The present invention can also provide a method of forming a gathered, stitchbonded fabric unit that is durable to multiple cycles of commercial laundering and use, comprising the steps of: (i) providing a nonwoven sheet comprising, consisting essentially of, or consisting of, one or more nonwoven sheet comprising, consisting essentially of, or consisting of, cellulosic fibers, as described herein; (ii) stitching the one or more nonwoven sheet using a pattern of stitches of a shrinkable yarns, to form a stitchbonded fabric unit comprising a plurality of yarn overlaps on a technical front of the nonwoven sheet and a plurality of yarn underlaps along the technical back of the nonwoven sheet, as described herein; and (iii) shrink-activating the plurality of shrinkable yarn stitches to gather the stitched fabric unit into a gathered stitchbonded fabric unit. In various embodiments, the gathered stitchbonded fabric unit provides reduced net area shrinkage of 20% or less, preferably 15% or less, and more preferably 10% or less, as determined by AATCC 61 through 5 cycles.

In various embodiments, the one or more nonwoven sheet has a ratio of a tensile strength in a machine-direction (MD) to a tensile strength in a cross-direction (CD) of about 5.0:1 or less, including 4.0:1 or less, and preferably a tensile strength ratio of 3.0:1 or less, more preferably about 2.0:1 or less, and even more preferably 1.5:1 or less.

In various embodiments, the stitchbonded fabric unit has a ratio of a tensile strength in a machine-direction (MD) to a tensile strength in a cross-direction (CD) of about 8.0:1 or less, including 6.0:1 or less, preferably about 4.0:1 or less, more preferably about 3.0:1 or less, and even more preferably about 2.0:1 or less.

The MD:CD tensile strength ratio of a nonwoven sheet can be determined prior to its forming by stitchbonding into a stitchbonded fabric, by measuring the tensile strength in the machine direction (MD) and the cross direction (CD).

For determining the MD:CD tensile strength ratio of the one or more nonwoven sheet after its stitchbonding, the stitching is cut and removed to recover a de-stitched nonwoven sheet or sheets, and the MD and CD tension strengths of the de-stitched nonwoven sheet or sheets is measured, and a ratio of MD:CD calculated.

The stitching of a nonwoven sheet(s) forms through holes throughout the nonwoven sheet, formed both by the stitching needles and the pulled-through yarns. Despite the through holes, the collective multidirectional orientation of the cellulosic fibers of a de-stitched nonwoven sheet taken from a stitchbonded fabric and of the un-stitched nonwoven sheet prior to stitching are similar, substantially the same, or the same, and consequently the calculated MD:CD ratio of the de-stitched nonwoven sheet or sheets taken from a stitchbonded fabric is similar, substantially the same, or the same, as the calculated MD:CD ratio of the un-stitched nonwoven sheet or sheets prior to the stitching. Preferably, an MD:CD ratio of a de-stitched nonwoven sheet is different by less than 35%, preferably less than 25%, more preferably less than 15%, even more preferably less than 10%, and even further more preferably less than 5%, than an MD:CD ratio of the un-stitched nonwoven sheet.

In various embodiments, the plurality of yarn underlaps comprise stitches formed in a zig-zag stitch pattern, angled in the cross direction (CD), that extends the advancing shrinkable yarn diagonally from a starting row to an adjacent row, or across the first adjacent row to a next second row, and then diagonally back to the starting row. When activated, the shrinking of the diagonal stitches can increase the tensile strength of the gathered stitchbonded fabric unit in the CD direction.

For determining the MD:CD tensile strength ratio of the one or more nonwoven sheet after being both stitchbonded and gathered, the gathered stitching is cut and removed to recover a gathered, de-stitched nonwoven sheet or sheets, and the MD and CD tension strengths of the gathered, de-stitched nonwoven sheet or sheets is measured, and a ratio of MD:CD calculated.

Similarly, the stitching and subsequent gathering of the nonwoven sheet(s) forms through holes throughout the nonwoven sheet, formed both by the stitching needles and the gathering of the pulled-through yarns. In general, and despite these through holes, the collective multidirectional orientation of the cellulosic fibers of a de-stitched nonwoven sheet taken from a gathered stitchbonded fabric, and of the un-stitched nonwoven sheet prior to stitching, are similar, substantially the same, or the same, and consequently the calculated MD:CD ratio of the de-stitched nonwoven sheet or sheets taken from a gathered stitchbonded fabric is similar, substantially the same, or the same, as the calculated MD:CD ratio of the unstitched nonwoven sheet or sheets prior to stitching. Preferably, an MD:CD ratio of a gathered, de-stitched nonwoven sheet is different by less than 35%, preferably less than 25%, more preferably less than 15%, even more preferably less than 10%, and even further more preferably less than 5%, than an MD:CD ratio of a gathered, de-stitched nonwoven sheet.

In various embodiments, the plurality of yarn underlaps comprise stitches formed in a zig-zag stitch pattern, angled in the cross direction (CD), that extends the advancing shrinkable yarn diagonally from a starting row to an adjacent row, or across the first adjacent row to a next second row, and then diagonally back to the starting row. When activated, the shrinking of the diagonal stitches can increase the tensile strength of the gathered stitchbonded fabric unit in the CD direction.

In the methods described herein, the cellulosic fibers of a nonwoven sheet, of a stitchbonded fabric or fabric unit, and/or of a gathered stitchbonded fabric or fabric unit, can comprise, consist essentially of, or consist of, lyocell fibers, cotton fibers, viscose fibers, or a mixture or combination thereof. In some preferred embodiments, the cellulosic fibers comprise, consist essentially of, or consist of, lyocell fibers. In some embodiments, the cellulosic fibers comprise, consist essentially of, or consist of cotton fibers. In some embodiments, the cellulosic fibers comprise, consist essentially of, or consist of viscose fibers.

### BRIEF DESCRIPTION OF THE FIGURES

FIGS. 1A and 1B show the opposite surfaces, respectively, of a single spunlaced multistrata lyocell sheet.

FIGS. 2A and 2B show the opposite surfaces, respectively, of a non-axial cross-lapped, spunlaced multistrata lyocell sheet.

FIG. 3A shows rows of pillar stitching of a yarn over the technical front surface of a stitchbonded lyocell fabric.

FIG. 3B shows rows of zigzag stitching of a yarn over the technical back of the stitchbonded lyocell fabric.

FIG. 4A shows rows of the activated pillar-stitched yarns and the nonwoven sheet gathered to form folds and puckers in the gathered stitchbonded lyocell fabric.

FIG. 4B shows rows of the activated zig-zag stitched yarns and the nonwoven sheet gathered to form folds and puckers in the gathered stitchbonded lyocell fabric.

### DETAILED DESCRIPTION OF THE INVENTION

### Definitions

The term “gather” means for a stitchbonded fabric unit to shrink and bulk when the shrinkable yarn and/or the one or more nonwoven sheet of the stitchbonded fabric unit are shrink-activated, causing the shrinkable yarn to contract and the nonwoven sheet to contract and increase in thickness, with a net effect of drawing inward the area of the stitchbonded fabric to form folds and puckers in the fabric unit.

The “unit” when referring to a fabric unit, unless otherwise indicated, a continuous elongated or rolled sheet, or a piece of fabric of fixed shape and dimensions, such as a rectangular or square fabric.

As used here, a “multidirectional” or “multidirectionally” when referring to a plurality of fibers in a stratum or nonwoven sheet means most (greater than a majority), and preferably substantially all (more than 90-95%), of the plurality of cellulosic fibers are oriented non-axially to, and at varying angles relative to, a main sheet direction of the stratum or a main sheet direction of the nonwoven sheet.

As used here, a “main sheet direction” for a sheet is the direction in which the sheet has the highest tensile strength. In typical nonwoven processing systems, the main sheet direction of a nonwoven sheet is typically the machine direction or “MD” of the nonwoven sheet.

As used here, a “main stratum direction” for a stratum is the direction in which the stratum has been aligned when applied during manufacture of the nonwoven sheet, and would typically be the direction of the stratum layer having the highest tensile strength.

As used herein, a “machine direction” is a direction parallel to the primary direction of movement during manufacture of the nonwoven material as it moves through a production machine; it is also the circumferential direction when the nonwoven materials is wound or unwound from a roll. Typically, the machine direction MD of a sheet is the main sheet direction.

As used herein, a “cross direction” is a direction perpendicular to the machine direction, and is across the width of the machine and across the width of the nonwoven material when wound or unwound from a roll.

### <<Multistrata Cellulosic Sheet>>

A nonlimiting embodiment of the present invention can use a multistrata nonwoven cellulosic sheet, comprising, consisting essentially of, or consisting of, cellulosic fibers oriented in a direction along and between a machine-direction (MD) and cross-direction (CD) plane. The orientation of the plurality of cellulosic fibers in each stratum is primarily non-axial to the main sheet direction of the nonwoven cellulosic sheet.

In various embodiments, the ratio of tensile strength of a multistrata nonwoven cellulosic sheet in a machine direction (MD) of the sheet, to the tensile strength in a cross-machine direction (CD) of the sheet, is 5.0:1 or less, including 4.0:1 or less. In some embodiments, the ratio of tensile strengths is 3.0:1 or less, more preferably 2.0:1 or less, and most preferably 1.5:1 or less.

A nonwoven sheet of cellulosic fibers can be made by a combination of forming cellulosic fibers into a web and bonding the cellulosic fiber web. Many options are known to those of ordinary skill in the art for forming and bonding a multistrata nonwoven sheet, including bonding, as non-limiting examples, by hydroentangling and needle punching. A multistrata nonwoven sheet can comprise, consist essentially of, or consist of, a spunlaced multistrata nonwoven sheet. A multistrata spunlaced nonwoven sheet can be made by a combination of web formation including carding of the cellulose fibers, and bonding that consists of hydroentanging the cellulose fibers.

A spunlace multistrata nonwoven sheet can comprise or consist of cellulosic fibers having a length of greater than 18 mm, preferably greater than 30 mm, that are opened and primarily aligned, and then laid onto a foraminous carrier in more than one stratum. More than one stratum is achieved by multiple doffing from one carding machine, or by more than one carding machine.

In the above embodiments described herein, the cellulosic fibers are selected from the group consisting of lyocell fibers, cotton fibers, viscose fibers, and a mixture or combination thereof, and preferably lyocell fibers.

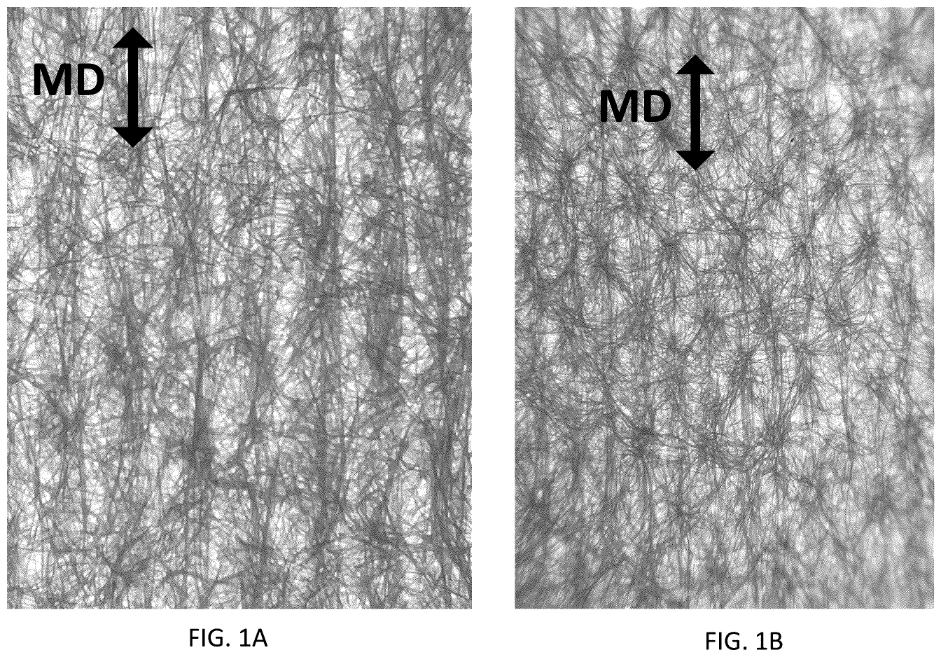

FIGS. 1A and 1B show the opposite surfaces of an example of a single spunlaced multistrata lyocell sheet (made by Norafin).

More than one stratum in a sheet is also achieved by crosslapping, or a combination with web drafting of the web.

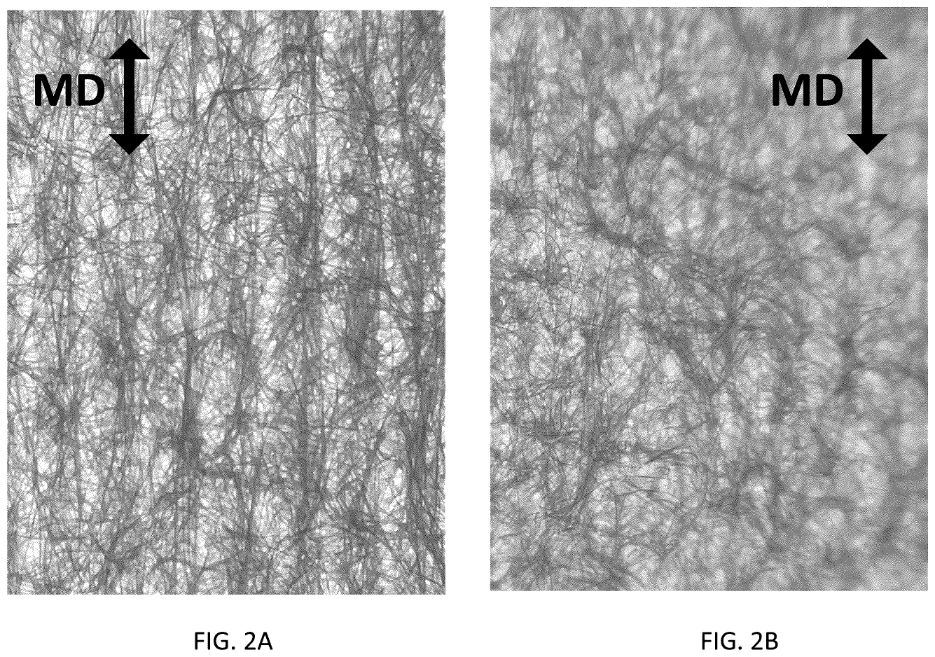

FIGS. 2A and 2B show the opposite surfaces of an example of a non-axial cross-lapped, multistrata lyocell sheet (made by Sateri).

The more than one stratum are continuously transported in the machine direction and come together at least immediately before entering a hydroentanglement area where the combined web of stratum is struck with a series of high pressure water jets that extend across the width of the web essentially perpendicularly to the direction of movement of the combined web to mechanically entangle and consolidate the fibers within and between the next stratum, to form a spunlaced multistrata nonwoven sheet having a machine direction and a cross direction.

In a preferred embodiment, no amount or concentration of fiber binders or adhesives are used that would interfere with a stitch bonding of the one or more multistrata nonwoven sheet. Preferably the one or more multistrata nonwoven sheet, which can be a spunlaced multistrata lyocell sheet, has no fiber binders or adhesives. A de minimis amount of binder fiber or adhesive material can be used, provided such presence and quantity that does not inhibit, interfere with, or otherwise impact the penetration of needles in the stitching process nor the gathering, absorbency and increase in thickness.

Following hydroentanglement the spunlaced multistrata nonwoven sheet is fully consolidated and homogenous with a compact surface displaying a de minimis amount of surface fiber protrusion.

In various embodiments, the spunlaced multistrata nonwoven sheet can have a basis weight of from about 20 grams per square meter (gsm) to about 120 gsm, preferably from about 50 gsm to about 90 gsm. In some embodiments, the spunlaced multistrata nonwoven sheet can have a basis weight of at least 20 gsm, or at least 30 gsm, or at least 40 gsm, or at least 50 gsm, and up to 120 gsm, or up to 110 gsm, or up to 100 gsm, or up to 90 gsm, or up to 80 gsm.

In various embodiments, the thickness of the spunlaced multistrata nonwoven sheet, as measured by surface thickness gauge according to ASTM D-5736, is at least 0.3 millimeters (mm), or at least 0.4 mm, or at least 0.5 mm, and up to 0.7 mm, or up to 0.6 mm, or up to 0.5 mm, or up to 0.4 mm.

In some embodiments, a spunlaced multistrata nonwoven sheet has, after being subjected to tensionless wet processing and drying using AATCC 61, a shrinkage of 3% or more, and preferably 5% or more, in the MD, and 2% or more, and preferably 3% or more, in the CD. For example, a 100% lyocell sheet having a basis weight of 68 gsm has, after being subjected to tensionless wet processing and drying using AATCC 61, a shrinkage of 8% in the MD and 4% in the CD.

In some embodiments, the spunlaced multistrata nonwoven sheet has, after being subjected to tensionless wet processing and drying, an increase in thickness from 0.40-0.60 mm to 0.80-0.90 mm. For example, a 100% lyocell sheet having a thickness of 0.46-0.52 mm, has, after being subjected to tensionless wet processing and drying using AATCC 61, an increase in thickness to 0.83-0.92 mm.

In some embodiments, the spunlaced multistrata lyocell sheet has a density of 0.15 gram per cubic centimeter (g/cm³) or less, preferably 0.1 g/cm³ or less after tensionless washing.

### <<Selection of Yarns for Stitchbonding>>

Stitchbonding is a subset of warp knitting using yarns that are fully set, having low levels of extensibility and do not shrink, or that have high extensibility or stretch, or having the potential to contract when exposed to subsequent heat and or wet processing.

In the present invention a selection of yarns for stitchbonding can be made for achieving the desired stabilization after stitchbonding. Stitchbonding yarns that are draw-textured yarn (DTY) have an inherent shrinkage potential that, after being stitched into the cellulosic nonwoven sheets, are activated to shrink in a subsequent post-treatment shrinkage process. The inherent shrinkage of a yarn, expressed as a percent reduction of the original length, is 3% or more, preferably 6% or more, more preferably 10% or more, and most preferably 12% or more, while a preferred maximum inherent shrinkage is 50% or less, or 40% or less, or 30% or less, as determined by a boiling water shrinkage (BWS) test ASTM D2259.

### <<Forming Stitchbonded Fabric>>

A stitchbonded cellulosic fabric comprises one or more nonwoven sheets, and by example, one or more multistrata nonwoven sheets or one or more spunlaced multistrata nonwoven sheets. The one or more cellulosic nonwoven sheet is introduced into the stitchbonding machine and stitched tensionlessly with at least one shrinkable stitching yarn to form a pattern of overlaps on a technical front and a pattern of underlaps along the technical back to form a stitchbonded fabric. The pattern of stitches is formed by the shrinkable stitching yarns that are not under tension and do not relax in situ within the stitchbonded cellulosic fabric, forming a plurality of yarn overlaps on a technical front surface of the fabric and yarn underlaps on a back surface of the fabric.

In various and selected embodiments, one of more of the stitches form a linear pattern, aligned in the machine direction (MD), such as a chain or pillar stitch, and one or more of the stitches may a zig-zag or 2-3/1-0 stitch, angled in the cross direction (CD), that bridge across rows and serve to reinforce the composite or to interlock with other stitches. The plurality of yarn underlaps comprise stitches formed in a zig-zag stitch pattern, angled in the cross direction (CD), that extends the advancing shrinkable yarn diagonally from a starting row to an adjacent row, or across the first adjacent row to a next second row, and then diagonally back to the starting row. When activated, the shrinking of the diagonal stitches can increase the tensile strength of the gathered stitchbonded fabric unit in the CD direction, and consequently, reduce the MD:CD ratio of the gathered stitchbonded fabric unit relative to the ungathered stitchbonded fabric unit.

In selected embodiments, the stitchbonding is made in a stitching pattern that can include but not be limited to a tricot pattern or a 3- or 4-row atlas pattern.

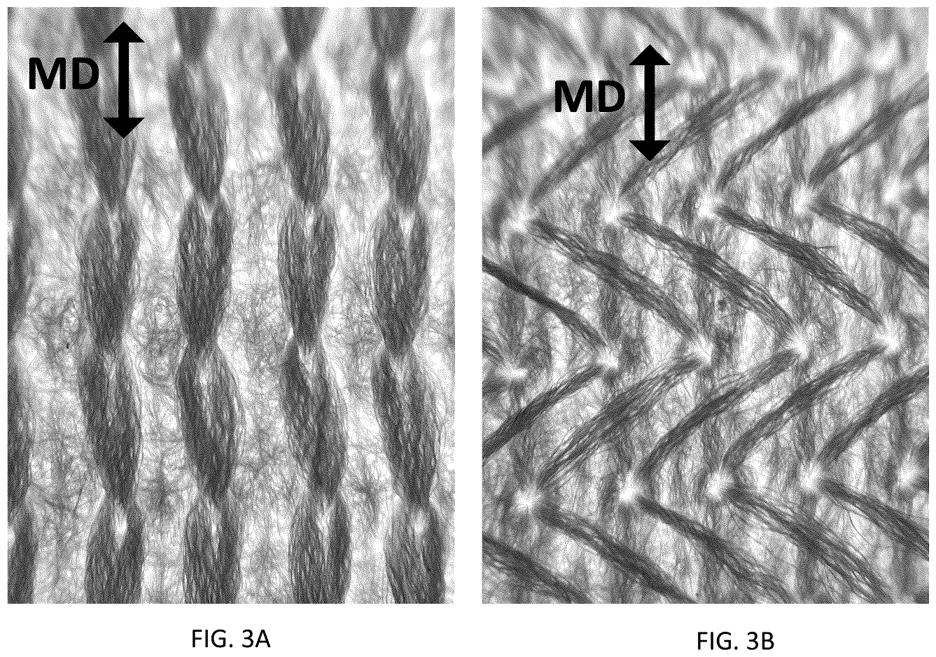

FIGS. 3A and 3B show opposed surfaces of a stitchbonded nonwoven sheet. FIG. 3A shows rows of pillar stitching of a 150d multifilament yarn over a technical front of the stitchbonded cellulosic fabric, and FIG. 3B shows rows of zig-zag stitching of another 150d multifilament yarn over a technical back of the stitchbonded cellulosic fabric.

The row spacing in the cross-machine direction, commonly referred to as ‘gauge’ is in the range of 5 to 25 rows per inch (2 to 10 rows per centimeter (cm)), for example, 12 to 18 rows per inch (5 to 7 rows per cm) while the course stitch spacing in the machine direction, commonly referred to as course per inch (or CPI) is in the range of 5 to 38 stitches per inch (2 to 15 stitches per centimeter), for example, 6 to 10 stitches per inch (2 to 4 stitches per cm). In a preferred embodiment the row spacing is about 14 per inch (6 per cm) and the course stitch spacing is about 7 to 10 stitches per inch (3-4 stitches per cm).

The stitchbonded cellulosic fabric as stitched is typically, and preferably, ungathered (the stitched yarns remain tensionless) and has a thickness between the front surface and the back surface of less than 1.0 mm, and a basis weight of 100 to 200 gsm.

### <<Shrinking of the Stitchbonded Cellulosic Fabric>>

The composite stitchbonded cellulosic fabric is caused to shrink after the stitching process, and not as part of the stitchbonding process. The composite stitchbonded fabric of cellulosic nonwoven sheets and stitched DTY yarns within the stitchbonded cellulosic fabric are activated to shrink by a post-treatment.

In an embodiment the composite stitchbonded fabric is formed into a plurality of stitchbonded fabric units with a stabilized boundary region along a portion of or the entire periphery of the fabric unit, by sewing, surging, ultrasonic bonding, or other method known to one of ordinary skill.

The stitchbonded cellulosic fabric units are activated to swell the cellulosic fibers in the one or more cellulosic nonwoven sheets, causing the shrinkable yarns to shrink or contract in situ, resulting in shrinkage and stabilization of the stitchbonded cellulosic fabric units.

In an embodiment the post treatment is carried out in a tensionless process, a non-limiting example thereof being in a laundering apparatus such as an industrial rotary or reciprocating washer.

A non-limiting example of activating and gathering a stitchbonded fabric is by a laundering process in a laundering apparatus at water and laundering conditions (quantity of water, temperature, and duration) sufficient to cause the shrinkable yarns and/or the cellulosic fibers of cellulosic nonwoven sheets to shrink and gather, to give bulk and thickness to the gathered stitchbonded fabric. A person of ordinary skill in the art would understand that an initial degree or extent of gathering in a post-treatment will increase with an increasing temperature and increasing tensionless wet treatment, towards a size-stable configuration having a nominal maximum of shrinking and gathering. Non-limiting examples of the activation conditions to achieve an initial degree or extent of gathering in a post treatment can include a liquor mass ratio of water to dry fabrics of at least about 3:1, typically up to about 10:1, and preferably about 5:1 to 6:1; a water temperature from about 80 degrees F. (27 degrees C.) or higher (for example, a cool rinse cycle temperature), up through about 100-120 degrees F. (38-49 degrees C.) (for example, a warm rinse cycle temperature), and up through to 175 degrees F. (79 degrees C.), including about 130 to 150 degrees F. (54-66 degrees C.) (for example, a hot rinse cycle temperature); and for at least 5 minutes, preferably about 10 minutes, and up to about 20 minutes. After extracting water in a spin cycle, the damp fabrics can be tumble dried at a temperature of from 110 degrees F. (43 degrees C.) to about 150 degrees F. (66 degrees C.), and preferably at about 120 degrees F. (49 degrees C.), for about 20 minutes or until dry.

In various embodiments, no binder fibers or adhesive material are used in the manufacture of the multistrata cellulosic sheets or the stitchbonded cellulosic fabrics, which would restrict or prevent the swelling of the cellulosic fibers and the shrinking of the stitching yarns, and the shrinking and gathering of the stitchbonded cellulosic fabric units, and which would interfere with achieving the desired bulking and thickness of the fabric, its reduction in fabric density, and the corresponding and resulting advantageous thermal properties.

The shrinkage and bulking (gathering) of the resulting stitchbonded cellulosic fabric is a combination of both the shrinkable yarns and the shrinkage and bulking of the multistrata cellulosic sheets. Consequently, the resulting properties, both physical properties and functional properties, are impacted by the selected yarns and nonwoven sheet(s).

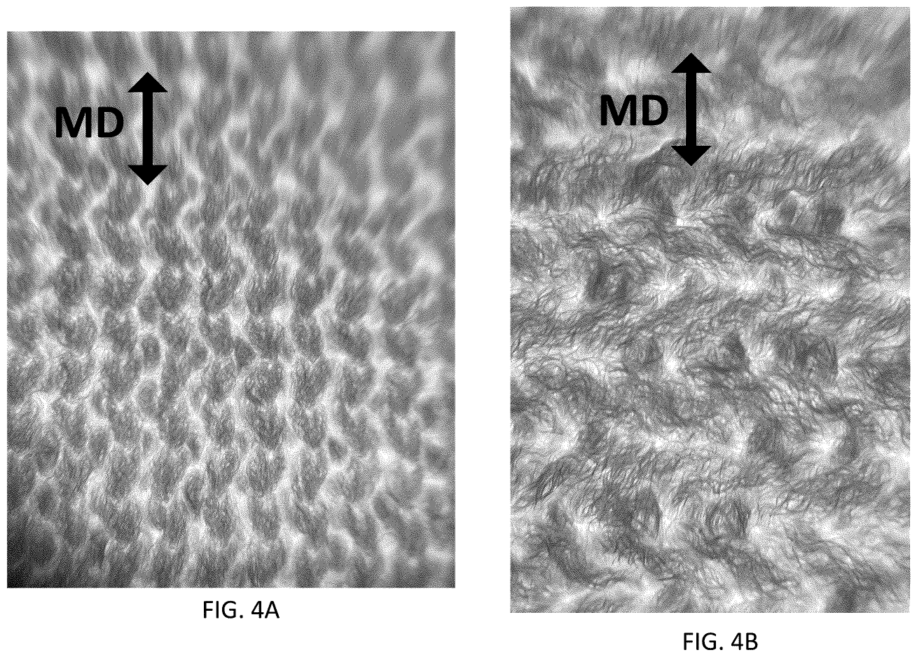

FIGS. 4A and 4B show opposed surfaces of a gathered stitchbonded fabric. FIG. 4A shows the rows of the activated pillar-stitched yarns and the nonwoven sheet gathered to form folds and puckers in the gathered stitchbonded cellulosic fabric. FIG. 4B shows the activated zig-zag stitched yarns and the nonwoven sheet gathered to form folds and puckers in the gathered stitchbonded cellulosic fabric.

In some embodiments, after stabilization shrinkage or gathering of the yarn, the gathered cellulosic fabric can be 85% or less in length than a length the starting stitchbonded cellulosic fabric immediately after tensionless stitching. In various embodiments, the gathered length can be 80% or less, including 75% or less, of the length of the stitchbonded cellulosic fabric unit.

In various embodiments the gathered stitchbonded fabric unit can have a basis weight of 200 gsm or more, a thickness of 1.2 mm or more, a density of 0.2 g/cm³ or less, an absorbency of 3 grams or more water per gram of fabric, and an area shrinkage of less than 10%.

The gathered, stitchbonded fabric has an increased thickness, relative to that of the ungathered stitchbonded fabric, of at least 30%. In some embodiments, the increased thickness is at least 40%, or at least 50%, or at least 60%, or at least 70%.

In some embodiments, the size and stitching pattern of the shrinkable yarns can provide a basis weight, relative to the total basis weight of the gathered, stitchbonded cellulosic fabric, of at least 2410%, including at least 4920%, and up to about 6070%, including up to about 55%.

In some embodiments, the cellulosic fiber density, the number of strata in a sheet, and the number of multistrata cellulosic sheets can provide a basis weight of cellulosic fibers, relative to the total basis weight of the gathered, stitchbonded fabric, of at least 4430%, including at least 4-540%, and up to 50%. In some embodiments, the basis weight of cellulosic fibers is at least 60%, and up to 8490%.

In some embodiments, the ratio of the basis weight of the cellulosic fibers to the basis weight of the shrinkable yarns can vary in a ratio of 4:1 or less, including 3.0:1 or less, and in some embodiments, a basis weight ratio of at least about 1:1.5, including at least about 1:1.

In one example, a single multistrata cellulosic sheet having a basis weight of 68 gsm that is stitched with 2 bars of 150 denier yarn, one yarn producing a pillar stitch and one yarn producing a 2-3/1-0 zig-zag pattern has a basis weight 240 gsm after post-treatment shrinking. In a second example, two multistrata cellulosic sheets (68 gsm) are stitched with 2 bars of 75 denier yarn, one yarn producing a pillar stitch on one surface, and one yarn producing a 2-3/1-0 zig-zag pattern on the opposite surface, the resulting gathered stitchbonded fabric after post-treatment shrinking having a basis weight of 260 gsm.

### <<Stability of the Finished Stitchbonded Cellulosic Fabric>>

An important finding of the present invention is that the gathered, stitchbonded cellulosic fabric of the present invention, after a post-treatment shrinkage process, is stable in further wet processing with progressive area shrinkage of 20% or less, preferably 15% or less, and more preferably 10% or less, tested by 5 cycles under AATCC 61.

The fabric is durable to multiple commercial launderings. The durability of the fabric means the fabric unit can continue to be used in the intended application(s) and undergoes numerous washes with no substantial change in the structural integrity, little or no surface breakdown, and resistant to hole formation, with good hand and appearance even under industrial laundering conditions.

### <<Thermal Effusivity>>

Thermal effusivity is an indication of warm feel, or cool touch, of a substrate or fabric. A thermal effusivity of less than 100 is considered a “warm touch”, which is a desirable property of a blanket used in a hospital and other patient settings. Thermal effusivity as used herein is measured in units of watts times square root of seconds per square meter Kelvin (Ws^{1/2}/m²K).

Fabrics are tested and the results measured for thermal effusivity according to ASTM Standard D-7984, using a C-Therm Thermal Conductivity Analyser (TCi) and a modified transient plane source (MTPS) instrument for measuring thermal conductivity of fabrics. Thermal conductivity (k) has the unit Watts per meter Kelvin (W/mK). Thermal resistance (R) has the unit meter squared Kelvin per Watt (m²K/W) and is the resistance to heat transfer of a material with a defined thickness (x) and is related to thermal conductivity (k), R=x/K. The lower the conductivity, the higher the resistance value and the slower the rate of heat transfer. Higher thermal conductivity leads to lower thermal resistance. Both thermal resistance (R) and CLO (a unit of thermal resistance, equal to R×6.45) are calculated from thermal conductivity. Higher CLO values provide more thermal insulation.

A CLO of 1 (unit) is the insulation value of typical indoor clothing at 21 degrees centigrade (C). For summer clothing, a CLO value can be 0.5. For comparison, 3M offers a ‘Thinsulate’ filling material (wadding/batting) for outerwear or sportswear that have CLO values from 1.3 to 3.0. CLO values of 4 to 5 would be for outdoor winter clothing with high insulation and heat retention properties. A flannel shirt is 0.3; a t-shirt is 0.08. Typical summer clothing is 0.5, and typical winter clothing is 1.0.

Thermal effusivity and conductivity of a material can stay the same but thermal resistance and CLO can be increased by thickness or having multiple layers of the material.

### EXAMPLES

### Example 1: Properties Testing Between Conventional and Invention Blankets

A commercial woven 80% cotton/20% polyester blanket (Conventional blanket) was provided (supplied by Encompass, model number 49277-717) having the properties shown in Table 1.

A stitchbonded lyocell fabric according to the present invention (Fabric 1) was made using a single spunlaced multistrata lyocell sheet (68 gsm, available from Norafin) and a tensionless stitching process using 150-denier yarn. One first yarn for a pillar stitching on the technical front of the multistrata lyocell sheet consisted of nylon 6 (1/150/34, 11.2% shrinkage, where “1/150/34” represents 1-plied filament yarn of 150 denier, having 34 filaments per filament yarn). A second yarn for a 2-3/1-0 zig-zag stitching on the technical back surface of the multistrata lyocell sheet consisted of polyester (1/150/34, 15% shrinkage). The stitching was 14 gauge, 8.8 cpi.

A second stitchbonded lyocell fabric according to the present invention (Fabric 2) was made using two spunlaced multistrata lyocell sheets (68 gsm, available from Norafin) and a tensionless stitching process using a 75-denier polyester yarn (1/75/36, 14.4% shrinkage) for zig-zag stitching, and a 75-denier nylon-6,6 yarn (1/75/34, 25.9% shrinkage). The stitching 14 gauge, 8.8 cpi.

The stitchbonded fabrics were activated and gathered by a laundering process in a laundering apparatus at a liquor ratio of 5:1 (5 pounds of water added for every 1 pound of dry weight of fabric units), at a temperature of 150 degrees F. (66 degrees C.) for 10 minutes. After a spin extract, the fabrics were tumble dried at 120 degrees F. (49 degrees C.) for 20 minutes.

The gathered stitchbonded lyocell Fabric 1 and Fabric 2 had the properties shown in Table I in comparison with the Conventional blanket.

TABLE I
Properties for Conventional and Invention Blankets

| | Conventional | | |
|---|---|---|---|
| Property | blanket | Fabric 1 | Fabric 2 |
| Basis weight (gsm) | 260 | 240 | 260 |
| Thickness (mm) | 1.2 | 1.7 | 1.7 |
| Density (g/cm³) | 0.22 | 0.14 | 0.15 |
| thermal effusivity | 120.9 | 81.8 | 76.1 |
| thermal conductivity | 0.0454 | 0.0386 | 0.0373 |
| thermal resistance | 0.0264 | 0.044 | 0.0455 |
| CLO | 0.17 | 0.284 | 0.294 |
| Water absorbency | 2.4 | 4.03 | 5.33 |
| (gm water/fabric) | | | |
| Area Shrinkage | 30% | 9% | 8% |
| AATCC 61, 5 cycles | | | |

### Example 2

Several gathered stitchbonded fabrics of the present invention were made having a single lyocell sheet and the yarns of Fabric 1 of Example 1. The gathered stitchbonded fabrics had a length shrinkage of 27% to 33% (effectively 30%±3%), with a basis weight is at 220-260 gsm, a thickness of 1.3 to 1.7 mm, a density of 0.13 to 0.20 gm/cm³ (weight per thickness), and a water absorbency of 3.5 to 4.5 gm water/gm fabric.

### Example 3

Several gathered stitchbonded fabrics of the present invention were made having two lyocell sheets and the yarns of Fabric 2 of Example 1. The gathered stitchbonded fabrics had a length shrinkage of 24% to 30% (effectively 27%±3%), with a basis weight is at 240-280 gsm, a thickness of 1.5 to 1.9 mm, a density of 0.126 to 0.187 gm/cm³ (weight per thickness), and a water absorbency of 4.5 to 5.5 gm water/gm fabric.

The resulting properties of the gathered stitchbonded fabrics of Examples 1-3 provide the following observations and conclusions.
1. Compared to the Commercial blanket, the lower effusivity of the Fabrics 1 and 2 indicated a warmer feel, and the lower conductivity, higher thermal resistance and higher CLO indicates a slower rate of heat transfer and therefore a better heat retention. This would be especially important for maintaining warmth around the body of a patient who may be sitting or lying down with lower metabolic rate.
2. An improved feeling of warmth and slower range of heat transfer are provided by Fabrics 1 and 2 despite having the same or even lower basis weight, and with a greater thickness, lower density, lower thermal effusivity and thermal conductivity, and a higher thermal resistance and CLO.
3. It can be calculated that for a similar Conventional blanket to have comparable thermal conductivity and thermal resistance properties to the Fabrics 1 and 2, a thickness of 2 mm would be required, which would increase the basis weight of such Conventional blanket from 260 gsm to 435 gsm. Such a thicker conventional blanket would be more expensive (basis on increased raw material content) and less efficient to process in the laundry (requiring a reduced number of fabric pieces per load, and thereby would require more washing loads to process the same number of blanket pieces, and taking washing capacity away from other laundry articles).

### Example 4: Effect of Stitchbonding and Gathering on the MD:CD Ratio of the Nonwoven Lyocell Sheet, the Stitchbonded Fabric, and the Gathered Stitchbonded Fabric

### Example 4A—Lyocell sheet

A nonwoven lyocell material made by Sateri (China) was used for making a stitchbonded fabric and a gathered stitchbonded fabric of the present invention. Each lyocell sheet (Lyocell 4A) was 71 gsm, and was measured for MD and CD tension strengths using ASTM D-5034, and a ratio of MD:CD calculated.

### Example 4B—Stitchbonded Fabric and its Lyocell Sheet

Two sheets of the nonwoven lyocell material of Example 4A were tensionlessly stitchbonded using yarns and stitching patterns as described in Example 1 for Fabric 2 (Stitchbonded Fabric 4B), and a portion of Stitchbonded Fabric 4B was measured for MD and CD tension strengths, and a ratio of MD:CD calculated. The yarn stitching from a remaining portion of Stitchbonded Fabric 4B was manually removed by cutting and pulling out the stitching, to recover a de-stitched stitchbonded lyocell sheet (Lyocell 4B), which was measured for MD and CD tension strengths, and a ratio of MD:CD calculated.

### Example 4C—Gathered Fabric and its Lyocell Sheet

Two sheets of the nonwoven lyocell material of Example 4A were tensionlessly stitchbonded using yarns and stitching patterns and then gathered as described in Example 1 for Fabric 2 (Gathered Fabric 4C), and a portion of Gathered Fabric 4C was measured for MD and CD tension strengths, and a ratio of MD:CD calculated. The yarn stitching from a remaining portion of Gathered Fabric 4C was manually removed by cutting and pulling out the stitching, to recover a de-stitched stitchbonded-and-gathered lyocell sheet (Lyocell 4C), which was measured for MD and CD tension strengths, and a ratio of MD:CD calculated.

The MD and CD tensions strengths and ratios thereof, for the Lyocell 4A, the Stitchbonded Fabric 4B, the Lyocell 4B, the Gathered Fabric 4C, and the Lyocell 4C, are reported in Table II below.

TABLE II
Tensile Strength Properties of Samples

| | MD | CD | Ratio | % Difference vs |
|---|---|---|---|---|
| Sample | (N/5 cm) | (N/5 cm) | (MD:CD) | Ratio Lyocell 4A |
| Lyocell 4A | 199.28 | 143.49 | 1.39:1 | — |
| Stitchbonded | 498.20 | 93.41 | 5.33:1 | — |
| Fabric 4B | | | | |
| Lyocell 4B | 57.83 | 33.36 | 1.73:1 | +24% |
| Gathered | 389.22 | 160.14 | 2.43:1 | |
| Fabric 4C | | | | |
| Lyocell 4C | 67.84 | 44.48 | 1.53:1 | +10% |

The results show the MD and the CD strengths of the de-stitched multistrata nonwoven sheet (Lyocell 4B), after the stitches from the stitchbonded fabric unit (Stitchbonded Fabric 4B) are cut and removed, are 29% and 23%, respectively, of those of the starting multistrata nonwoven sheet (Lyocell 4A), whilst the MD:CD tensile strength ratio of the de-stitched multistrata nonwoven sheet (Lyocell 4B) is about 24% higher than that of the starting multistrata nonwoven sheet (Lyocell 4A). The de-stitched multistrata nonwoven sheet (Lyocell 4B), despite having been altered by stitchbonding, still had an MD:CD of less than 2.0:1.

Consequently, an estimate can be made of a MD:CD tensile strength ratio, and of the MD and CD tensile strengths of a starting multistrata nonwoven lyocell sheet, prior to its stitching, based on the MD and CD tensile strengths of the de-stitched stitchbonded lyocell sheet obtained after the yarn stitches are cut and removed from the stitchbonded fabric unit.

The results also show the MD and the CD strengths of the de-stitched multistrata nonwoven sheet, after the stitches are cut and removed from the gathered stitchbonded fabric unit (Gathered Fabric 4C), are 34% and 31%, respectively of those of the starting multistrata nonwoven sheet (Lyocell 4A), whilst the MD:CD tensile strength ratio of the de-stitched multistrata nonwoven sheet (Lyocell 4C) is about 10% higher than that of the starting multistrata nonwoven sheet (Lyocell 4A). The de-stitched multistrata nonwoven sheet (Lyocell 4C), despite having been altered by stitchbonding and gathering, still had an MD:CD of less than 2.0:1.

Consequently, an estimate can be made of MD:CD tensile strength ratio, and of the MD and CD tensile strengths of the starting multistrata nonwoven sheet, prior to its stitching and gathering, based on the MD and CD tensile strengths of the de-stitched stitchbonded-and-gathered lyocell sheet obtained after the yarn stitches are cut and removed from the gathered stitchbonded fabric unit.

Because the instant application is a continuation-in-part application, to the extent any amendments, characterizations, or other assertions previously made (in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be re-visited.

1. A stitchbonded fabric unit, consisting essentially of:
(i) one or more nonwoven sheet consisting essentially of a plurality of cellulosic fibers, the plurality of cellulosic fibers oriented multidirectionally within the one or more nonwoven sheet; and
(ii) a pattern of stitches of a shrinkable yarn that form a plurality of yarn overlaps over a technical front surface of the one or more nonwoven sheet and a plurality of yarn underlaps over a technical back surface of the one or more nonwoven sheet;
wherein the un-stitched one or more nonwoven sheet has a ratio of a tensile strength in a machine direction (MD) to a tensile strength in a cross direction (CD) of about 3.0:1 or less.

2. The stitchbonded fabric unit according to claim 1 wherein the stitchbonded fabric unit has a ratio of a tensile strength in an MD to a tensile strength in a CD of about 6.0:1 or less.

3. The stitchbonded fabric unit according to claim 1, wherein the plurality of cellulosic fibers of the one or more nonwoven sheet comprises about 30% to about 90% and the shrinkable yarn comprises about 10% to about 70%, by weight of the stitchbonded fabric unit.

4. The stitchbonded fabric unit according to claim 3, wherein the one or more nonwoven sheet comprises a multistrata nonwoven sheet consisting essentially of two or more strata, wherein the plurality of cellulosic fibers of each stratum are oriented non-axially to a main direction of the one or more nonwoven sheet.

5. The stitchbonded fabric unit according to claim 4, wherein the plurality of cellulosic fibers consist of a plurality of lyocell fibers.

6. The stitchbonded fabric unit according to claim 5, wherein the one or more nonwoven sheet contains essentially no binding fibers or adhesive material.

7. The stitchbonded fabric unit according to claim 1, wherein the one or more nonwoven sheet comprises a multistrata nonwoven sheet consisting essentially of two or more strata, wherein the plurality of cellulosic fibers of each stratum are oriented non-axially to a main direction of the one or more nonwoven sheet.

8. The stitchbonded fabric unit according to claim 1, wherein the plurality of cellulosic fibers consist of a plurality of lyocell fibers.

9. The stitchbonded fabric unit according to claim 1, wherein the one or more nonwoven sheet contains essentially no binding fibers or adhesive material.

10. A gathered stitchbonded fabric unit, consisting essentially of:
(i) one or more nonwoven sheet with a machine direction MD and a cross direction CD, consisting essentially of a plurality of cellulosic fibers comprising about 30% to about 90% by weight of the gathered stitchbonded fabric unit, wherein the plurality of cellulosic fibers are oriented multidirectionally within the one or more nonwoven sheet; and
(ii) a pattern of stitches of a shrunken yarn that gather the one or more nonwoven sheet, forming a plurality of yarn overlaps over a technical front surface and yarn underlaps over a technical back surface of the gathered one or more nonwoven sheet, the shrunken yarn comprising about 10% to about 70% by weight of the gathered stitchbonded fabric unit;
wherein the un-stitched one or more nonwoven sheet has a ratio of a tensile strength in a machine direction (MD) to a tensile strength in a cross direction (CD) of about 3.0:1 or less.

11. The gathered stitchbonded fabric unit according to claim 10, wherein the gathered stitchbonded fabric unit has a ratio of a tensile strength in an MD to a tensile strength in a CD of 4.0:1 or less.

12. The gathered stitchbonded fabric unit according to claim 10, wherein the one or more nonwoven sheet comprises a multistrata nonwoven sheet consisting essentially of two or more strata, wherein the plurality of cellulosic fibers of each stratum are oriented non-axially to a main direction of the one or more nonwoven sheet.

13. The gathered stitchbonded fabric unit according to claim 12, wherein the plurality of cellulosic fibers consist of a plurality of lyocell fibers.

14. The gathered stitchbonded fabric unit according to claim 13, wherein the one or more nonwoven sheet contains essentially no binding fibers or adhesive material.

15. The gathered stitchbonded fabric unit according to claim 10, wherein the plurality of cellulosic fibers consist of a plurality of lyocell fibers.

16. The gathered stitchbonded fabric unit according to claim 10, wherein the one or more nonwoven sheet contains essentially no binding fibers or adhesive material.

17. The gathered stitchbonded fabric unit according to claim 10, wherein the gathered stitchbonded fabric unit has a progressive area shrinkage of 20% or less, through 5 cycles of testing according to AATCC 61.

18. The gathered stitchbonded fabric unit according to claim 10, wherein the plurality of yarn underlaps comprise stitches formed in a zig-zag stitch pattern, angled in the cross direction (CD), that extend the advancing shrinkable yarn diagonally from a starting row to an adjacent row, or across the first adjacent row to a next second row, and then diagonally back to the starting row.

19. A method for making a gathered stitchbonded fabric unit, comprising the steps of:
i) providing one or more nonwoven sheet with a machine direction MD and a cross direction CD, the one or more nonwoven sheet consisting essentially of a plurality of cellulosic fibers oriented multidirectionally to provide the one or more nonwoven sheet with a ratio of a tensile strength in a machine direction (MD) to a tensile strength in a cross direction (CD) of about 3.0:1 or less;
ii) stitchbonding the one or more nonwoven sheet with a pattern of stitches of a shrinkable yarn to form a stitchbonded fabric unit, wherein the pattern of stitches includes a plurality of yarn overlaps over a technical front surface of the one or more nonwoven sheet and a plurality of yarn underlaps over a technical back surface of the one or more nonwoven sheet; and
iii) shrink-activating the stitchbonded fabric unit to shrink the shrinkable yarn and gather the stitchbonded fabric unit into the gathered stitchbonded fabric unit.

20. The method according to claim 19 wherein the gathered stitchbonded fabric unit has a ratio of a tensile strength in an MD to a tensile strength in a CD of 4.0:1 or less.
